(19) United States
(12) Patent Application Publication
(10) Pub. No.: US 2025/0196076 A1
(43) Pub. Date: Jun. 19, 2025

(54) MIXING DEVICES AND METHOD OF MIXING A COMPOSITION

(71) Applicants: BAXTER INTERNATIONAL INC., Deerfield, IL (US); BAXTER HEALTHCARE SA, Glattpark (Opfikon) (CH)

(72) Inventor: Yves A. Delmotte, Neufmaison (BE)

(21) Appl. No.: 18/847,146

(22) PCT Filed: Mar. 6, 2023
(86) PCT No.: PCT/US2023/063770

§ 371 Date: Sep. 13, 2024

Related U.S. Application Data
(60) Provisional application No. 63/319,599, filed on Mar. 14, 2022.

(51) Int. Cl. B01F 25/452; B01F 23/40; B01F 23/45; B01F 33/81; B01F 101/36

(52) U.S. Cl. CPC B01F 25/4522; B01F 23/405; B01F 23/45; B01F 33/811; B01F 2101/36

(57) ABSTRACT

Disclosed herein are devices for mixing liquids having a gradient or varying degrees of viscosity and methods of using the same.

### CROSS REFERENCE TO RELATED APPLICATION

The present application claims the benefit of U.S. Provisional Application No. 63/319,599, filed Mar. 14, 2022, the entire contents of which is incorporated by reference herein.

### FIELD

The present specification relates to devices and methods for mixing fluids having various degrees of viscosity.

### BACKGROUND

Fibrin glue consists of two main components: fibrinogen and thrombin. These components can be loaded into two syringes with tips forming a common port. When simultaneously injected, the two components meet in equal volumes at the point of delivery and have to be mixed in order to generate an efficient, homogeneous and well structured fibrin network. The herein described devices and methods aim to overcome issues encountered when mixing fibrin glue components.

### SUMMARY

In some embodiments, devices are described that can be easy to manufacture, cheap and efficient for mixing liquids having a gradient or varying degrees of viscosity. When mixing thrombin and fibrinogen, for example, a main challenge resides in the difference in properties of the two fluids to be mixed. Thrombin has a viscosity close to that of water while fibrinogen is at least 100 times more viscous.

Mixing thrombin and fibrinogen more efficiently can be achieved using the devices as described herein.

The devices described herein can include one or more mixing discs. When using one or more mixing discs, mixing capability of the discs is based on the Darcy Law which is governed by the equation:

$$Δ P = ( Qnl ) / Sk$$

where:
delta P (ΔP): is the difference of pressure between entry and exit of the porous media
Q: is the liquid flow rate
n: is the viscosity of the fluid
S: is the surface of the section
k: is the porosity of the disc

If:
the two fluids, thrombin and fibrinogen, which are flowing through the same porous disc,
thrombin that has a lower viscosity than fibrinogen, and
the same pressure at the entry into the porous disc, the pressure difference at the exit of the disc is:

$$Δ {P}^{thrombine} = ( {Qn}^{thrombine} xL ) / Sk < Δ {P}^{fibrinogen} = ( {Qn}^{fibrinogen} xL ) l Sk$$

The gradient of pressure at the exit of the porous disc contributes to the quality of mixing of the two liquids and builds up.

In some embodiments, mixing devices can include: an inlet, a tube, a first mixing disc, a second mixing disc, and an outlet, wherein the first mixing disc, the second mixing disc, or a combination thereof include a truncation, a masking, or a combination thereof. In some embodiments, three or more mixing discs are included.

In other embodiments, the mixing devices can be configured to mix a composition including a first liquid having a first viscosity and a second liquid having a second viscosity wherein the second viscosity is greater than the first viscosity. In some embodiments, the second viscosity is less than the first viscosity.

In some embodiments, discs are porous and/or formed of a porous material.

In other embodiments, the first disc includes a truncation.

In other embodiments, the second disc includes a truncation.

In other embodiments, the first disc includes a masking.

In other embodiments, the second disc includes a masking.

Methods of mixing compositions using the herein described mixing devices are also described herein.

### BRIEF DESCRIPTION OF THE DRAWINGS

FIG. 1 illustrates a mixing device including at least two mixing discs.

FIG. 2 illustrates the viscosity between two liquids that travel through a mixing disc.

FIGS. 3A-C illustrate truncated discs.

FIG. 4 illustrates two discs each with 45 degree segments which are oriented opposite each other.

FIGS. 5A-C illustrate discs including masked portions.

FIGS. 6A-E illustrate discs including masked portions oriented relative to one another and the viscosity gradients. FIG. 6A is presented as a key for FIGS. 6B-E. Therein, portions labeled “M” represent liquid tight masked portions and portions labeled “1,” “2,” “3,” or “4” representing orientation numbers. For each mixing device configuration, in order of flow, a first disc is labeled L1, a second L2, a third L3, etc., and each disc is then identified by an orientation number as described. FIG. 6B represents a configuration of L1,3:L2,1. FIG. 6C represents a configuration of L1,2:L2,4. FIG. 6D represents a configuration of L1,2:L2,1. FIG. 6E represents a configuration of L1,3: L2,1, wherein the porous portions are replaced by voids.

FIG. 7A illustrates a side view and FIG. 7B illustrates a top view of an experimental setup for assessing characteristics of the devices described herein.

FIG. 7A illustrates a side view and FIG. 7B illustrates a top view of a system used to measure viscosity gradients of the devices described herein.

FIG. 8 illustrates a setup used as a control including porous discs.

FIG. 9 illustrates data using porous discs as illustrated in FIG. 8. Regarding the graphs in FIGS. 8-14, the x-axis are not normalized. A vertical line is drawn on each graph at position 2.25 in order to compare the data over the same portion of tube diameter. Mixing quality can be represented by the surface under the curve and how that surface covers the whole section of the tube, from 0 mm to 3.0 mm on the X axis.

FIG. 10 illustrates data using discs that are truncated 45 degrees.

FIG. 11 illustrates data using discs parallel to the interface in a L1,3:L2,1 configuration.

FIG. 12 illustrates data using discs perpendicular to the interface in a L1,2:L2,4 configuration.

FIG. 13 illustrates data using discs perpendicular to each other in a L1,2:L2,1 configuration.

FIG. 14 illustrates data masks in a L1,3:L2, 1 for the voids configuration.

FIG. 15 illustrates a schematic view of flow rate and mixing without and with a mixing disc.

FIG. 16 illustrates a schematic of flow rate and mixing with mask 50% in baffle, without a mixing disc.

### DETAILED DESCRIPTION

In some embodiments, devices are described that can mix liquids having a gradient or varying degrees of viscosities. The devices include one or more, or in some embodiments, two or more mixing discs. These mixing discs can have various modifications. Modifications can include, partial masking and/or partial truncations. In some embodiments, a masking or partial masking can be used in place of or in addition to a porous disc.

Mixing discs as described herein can be any disc shaped object used to mix the multiple liquids transitioning the device. Mixing discs can be formed of a porous material. In some embodiments, portions of a porous disc may be masked thereby preventing liquid egress. In still some other embodiments, mixing discs may only include portions that are masked (reminder void space) and not include any portions that are porous.

In one embodiment, the devices described herein can be used to mix thrombin and fibrinogen.

In some embodiments, depending on the liquids being mixed, the application time of the resulting mixture can be less than about 5 seconds, less than about 10 seconds, less than about 15 seconds, less than about 20 seconds, less than about 25 seconds, or less than about 30 seconds.

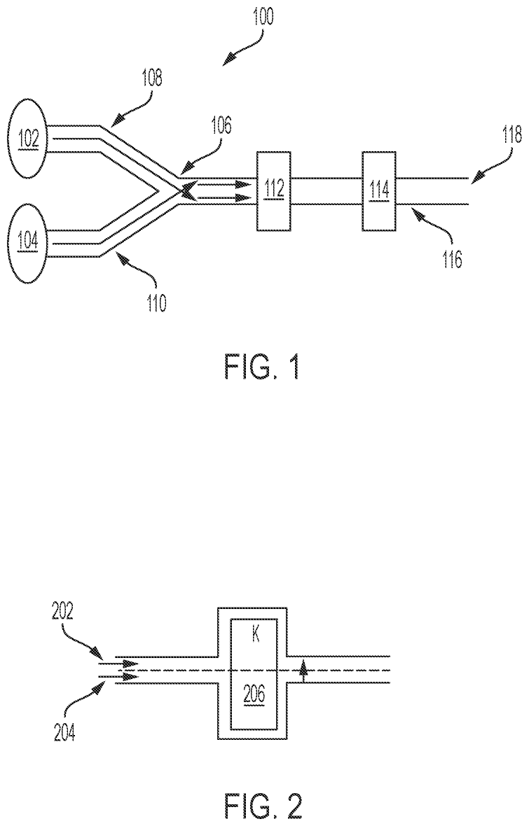

A general mixing device is illustrated in FIG. 1. Mixing device 100 includes a first inlet 102 and a second inlet 104. These inlets lead to a y-connection 106 through first tube 108 and second tube 110. After meeting at y-connection 106, the liquids delivered through each inlet pass through first mixing disc 112 and second mixing disc 114 as they traverse main tube 116. Ultimately, the liquids flow out exit 118.

If some type of turbulence is not created as the liquids are introduced to one another, the two liquids may exhibit a laminar flow pattern.

In some embodiments, the devices can include at least two mixing discs. In other embodiments, the devices can include, 3, 4, 5, 6, 7, 8, 9, 10, or more mixing discs.

In some embodiments, the devices can include at least two inlets for liquids. In other embodiments, the devices can include, 3, 4, 5, 6, 7, 8, 9, 10, or more inlets.

As illustrated in FIG. 2, first liquid 202 and second liquid 204 possess a gradient of viscosity due to their differing viscosities. As the liquids pass through mixing disc 206, the gradient of viscosity depresses into the area of the first liquid thereby decreasing the initial gradient.

Each mixing disc as described herein can have an independent shape and orientation. These shapes and orientations can assist in mixing two or more liquids to create a homogenous mixture at the exit of a device.

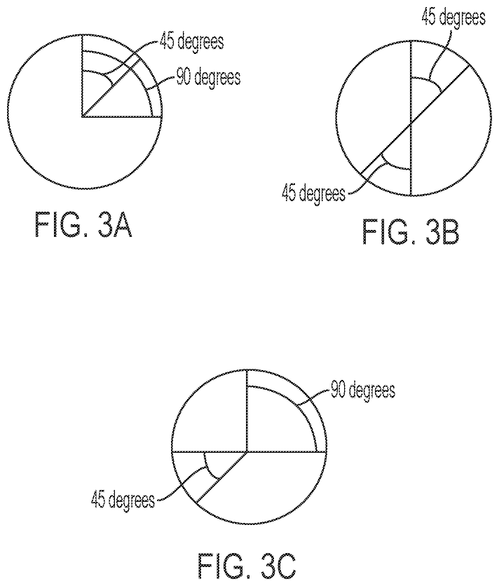

In some embodiments, a portion of a disc can be truncated. For example, as illustrated in FIG. 3A, a 45 degree segment or a 90 degree segment can be removed from a disc. In other embodiments, more or less can be removed from the disc resulting in larger or smaller degrees of truncation.

In other embodiments, multiple segments can be removed from a disc. For example, as illustrated in FIG. 3B, two 45 degree segments can be removed from a disc. In other embodiments, more or less can be removed from each segment on the disc resulting in larger or smaller degrees of truncation from each disc. Further, each removed segment can be independently sized. For example, a disc can include both a 45 degree and a 90 degree segment as illustrated in FIG. 3C.

Further still, each segment can be independently oriented around the circular axis of the disc. In other words, the segments need not be symmetric. This arrangement is illustrated in FIG. 3C wherein the segments are not aligned.

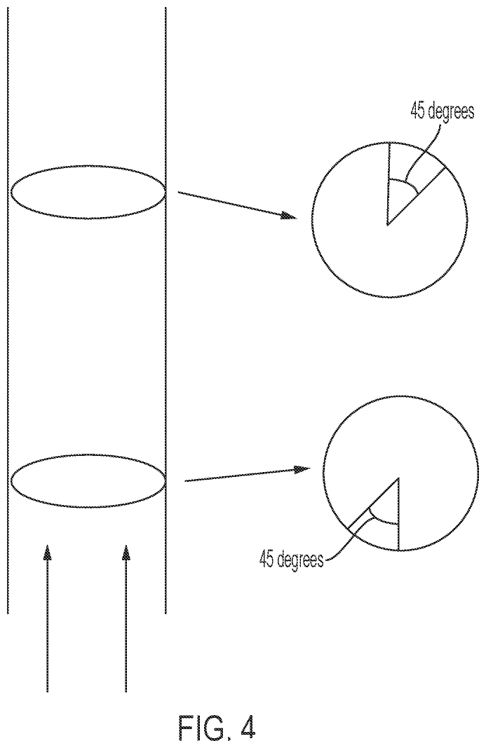

When two or more discs are used, truncations in discs can be oriented independently of each other. For example, as illustrated in FIG. 4, two discs each with 45 degree segments are oriented opposite each other. Such a device configured in this manner is referred to herein as Device 2.

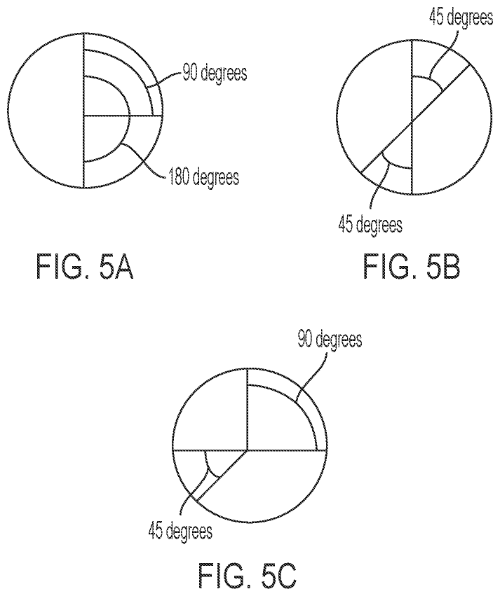

In other embodiments, a portion of a disc can be masked, meaning that the masked portion blocks liquid egress. For example, as illustrated in FIG. 5A, a 180 degree mask or a 90 degree mask can be added to a disc. In other embodiments, more or less can be masked on the disc resulting in larger or smaller degrees of masking.

In other embodiments, multiple segments can be masked on a disc. For example, as illustrated in FIG. 5B, two 45 degree segments can be masked on a disc. In other embodiments, more or less can be masked on each disc resulting in larger or smaller degrees of masking. Further, each masked segment can be independently sized. For example, a disc can include both a 45 degree and a 90 degree mask as illustrated in FIG. 5C.

Further still, each masked segment can be independently oriented around the circular axis of the disc. In other words, the segments need not be symmetric. This arrangement is illustrated in FIG. 5C wherein the masked segments are not aligned.

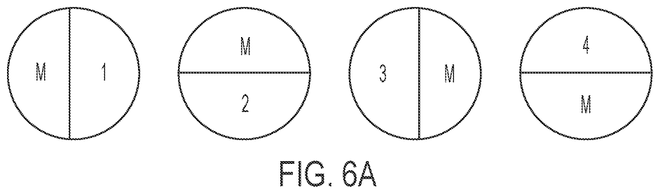

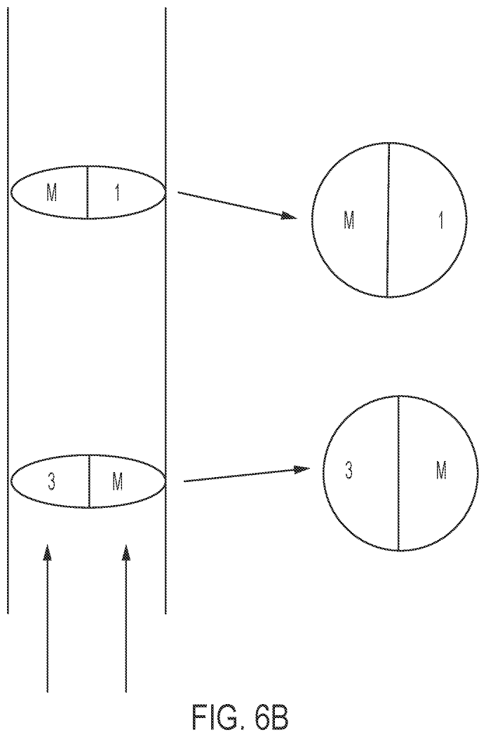

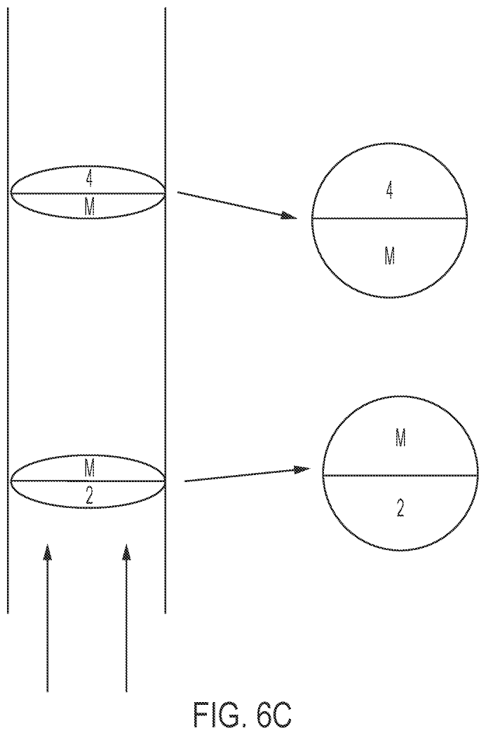

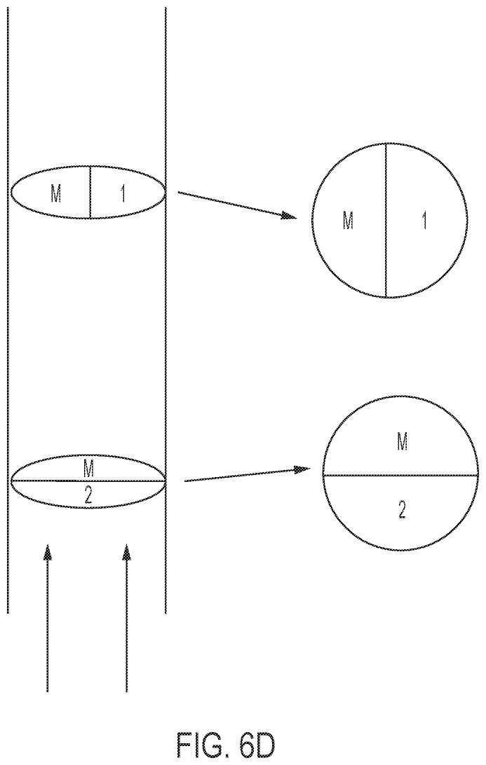

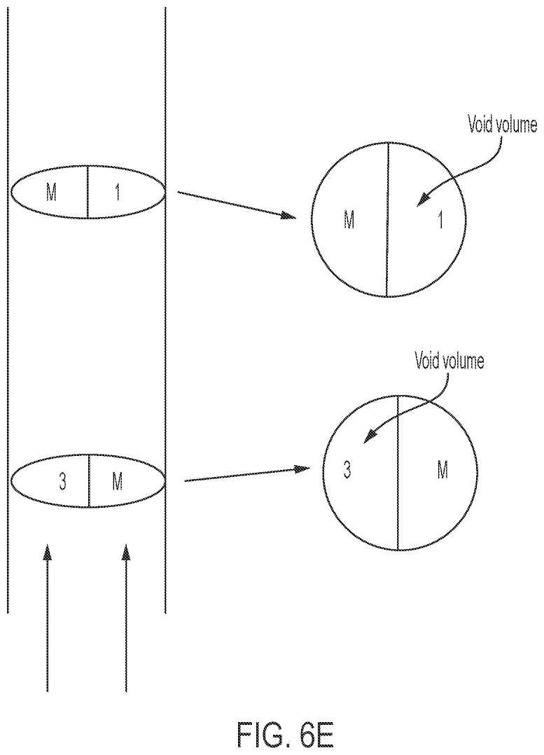

When two or more discs are used, maskings on discs can be oriented independently of each other. For example, as illustrated in FIG. 6B, two discs each with 180 degree maskings are oriented opposite each other or parallel to the interface. Such a device configured in this manner is referred to herein as Device 3.

In FIG. 6C, two discs each with 180 degree maskings are oriented opposite each other or perpendicular to the interface. Such a device configured in this manner is referred to herein as Device 4.

In FIG. 6D, two discs each with 180 degree maskings are oriented perpendicular to each other. Such a device configured in this manner is referred to herein as Device 5.

In FIG. 6E, two maskings each 180 degree are oriented opposite each other or parallel to the interface. Such a device configured in this manner is referred to herein as Device 6.

In one embodiment, devices can include three discs. The three discs can be in a L1,2:L2,1:L3,3 configuration. In one embodiment, the configuration includes masking only and no porous portions. In other embodiments, porous portions can be included in the first and third discs only. In other embodiments, a porous portion can be included in the second disc only. In other embodiments, porous portions can be included in the first and second discs only. In other embodiments, porous portions can be included in the second and third discs only.

In one embodiment, devices can include four discs. The four discs can be in a L1,2:L2,1:L3,3:L4,4 configuration. In one embodiment, the configuration includes masking only and no porous portions. In other embodiments, porous portions can be included in the first and third discs only. In other embodiments, a porous portion can be included in the second and fourth discs only. In other embodiments, porous portions can be included in the first and second discs only. In other embodiments, porous portions can be included in the second and third discs only. In other embodiments, porous portions can be included in the third and fourth discs only. In other embodiments, porous portions can be included in the first and fourth discs only. In other embodiments, a porous portion can be included in the first disc only. In other embodiments, a porous portion can be included in the second disc only. In other embodiments, a porous portion can be included in the third disc only. In other embodiments, a porous portion can be included in the fourth disc only.

Methods of use can include providing a first liquid having a first viscosity and a second liquid having a second viscosity wherein the second viscosity is greater than the first viscosity. The first and second liquids are mixed using a first mixing disc and a second mixing disc.

The methods and devices described can enhance mixing by 40% relative to using two porous discs. In other embodiments, the methods and devices described can enhance mixing by at least 15%, at least, 20%, or at least 30% relative to using two porous discs.

In other embodiments of both the devices and methods described herein, the first and second liquids are mixed using a first mixing disc and a second masking without a disc.

In other embodiments of both the devices and methods described herein, the first and second liquids are mixed using a first masking without a disc and a second masking without a disc.

In other embodiments of both the devices and methods described herein, the first and second liquids are mixed using a first truncated mixing disc and a second mixing disc.

In other embodiments of both the devices and methods described herein, the first and second liquids are mixed using a first truncated mixing disc and a second truncated mixing disc.

In other embodiments of both the devices and methods described herein, the first and second liquids are mixed using a first truncated mixing disc and a second truncated mixing disc both perpendicular to each other.

In other embodiments of both the devices and methods described herein, the first and second liquids are mixed using a first truncated mixing disc and a second truncated mixing disc both parallel to each other.

In some embodiments, mixing can be obtained from a mixing device generating turbulences and transverse motion of the flow. Factors can include, but are not limited to, design of the discs (e.g., level of porosity), number of discs, position of the discs, injection tip and position relative to the first disc, disc spacing, and component viscosities.

### EXAMPLES

The following non-limiting Examples are provided for illustrative purposes only in order to facilitate a more complete understanding of representative embodiments. This example should not be construed to limit any of the embodiments described in the present specification.

### Example 1

To model mixing a fibrin glue including a thrombin and a fibrinogen as described herein, liquids possessing similar viscosities to thrombin and fibrinogen are used. These liquids are water and glycerin. Water has a viscosity similar to that of thrombin. Glycerin has a viscosity similar to that of fibrinogen. Glycerin used can be about 87% w/v and have a viscosity of about 120 cP.

In order to visualize and quantify the proportion of one fluid in the flow constituted of the two liquids, a dye is added to the water component. That day can be a fluorescent dye such as Rhodamine 6G. This dye has an excitation wavelength at 492 nm and an emission wavelength at 530 nm.

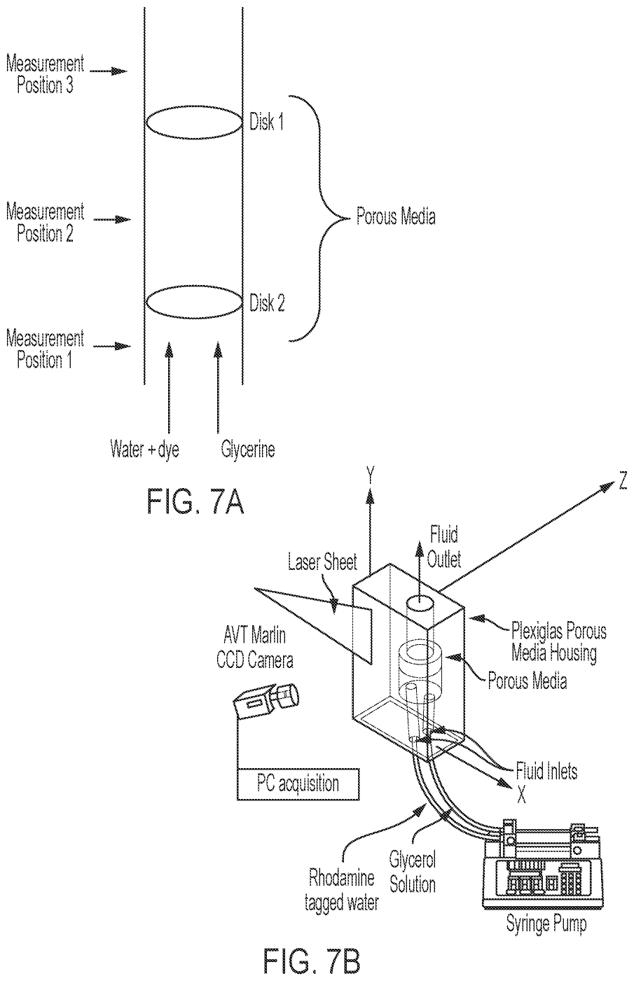

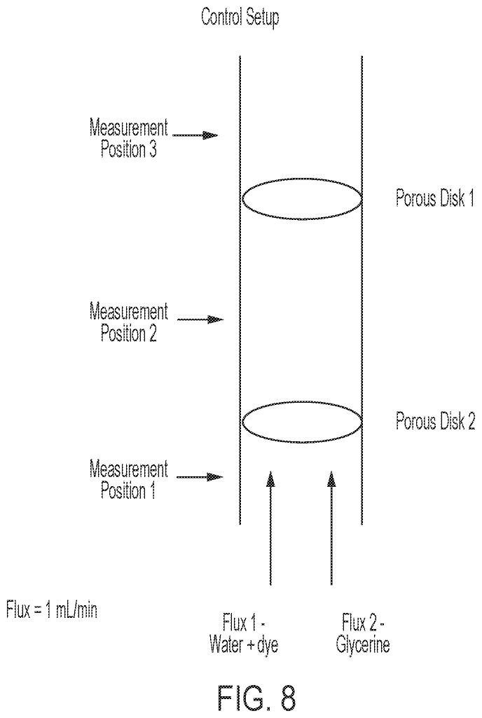

The experimental setup is illustrated in FIGS. 7 and 8. This set-up is used to test different combinations of mixing devices. It is very difficult to study flow at turbulent regime, so it is assumed that if a system is better than another at low flow, it will also be better at turbulent flow. Based on this hypothesis, all the tests are performed at low flow rate (stationary flow rate) (0.1 mL/min).

In this experimental setup, the mixing device can have an exit diameter of about 2.5 mm to about 3 mm and the distance between each disc is between about 5 mm and about 10 mm.

Planar laser induced fluorescence (PLIF) is used focusing a laser sheet at the mixing area of the mixing device being tested. Also, a camcorder is positioned after the second filter allowing imaging of the resulting flow.

The dye is excited at its excitation wavelength inside of the flow and its emission is measured using fluorescence.

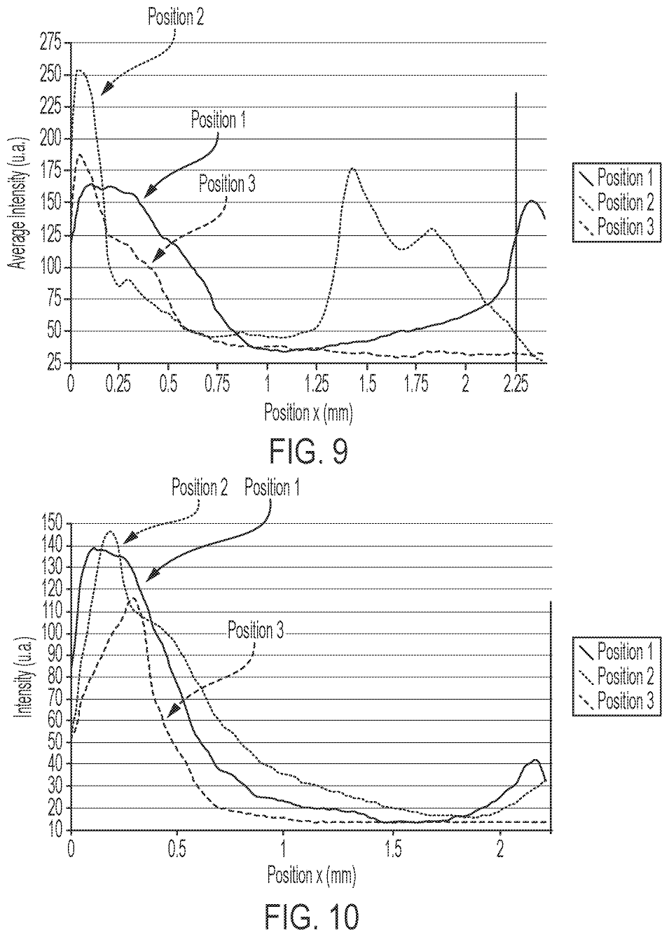

An apparatus setup as a control is illustrated in FIG. 8. Therein, two porous discs are used. Data from this apparatus are illustrated in FIG. 9, and such a device configured in this manner is referred to herein as Device 1.

Data from an experimental setup of Device 2 (illustrated in FIG. 4) is shown in FIG. 10. These two porous discs are truncated 45 degrees. Data obtained with Device 2 shows that the position 3 line curve is shifting slightly to the right resulting in a mixing improvement. Curves obtained at position 1, 2, and 3 have similar patterns. The estimated mixing rate of Device 2 is about 15%.

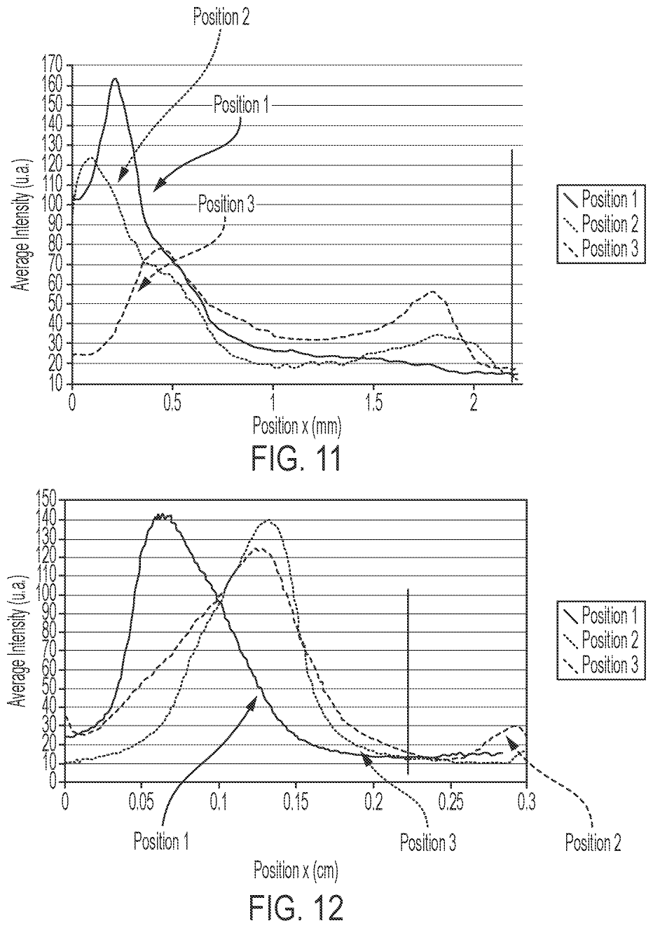

Data from an experimental setup of Device 3 (illustrated in FIG. 6B) is shown in FIG. 11. These two discs are masked 50% in baffle and parallel to the interface.

Device 3 has a second disc in the L2,1 configuration (same as the Device 5, discussed infra). Device 3 favors a shifting of the position 3 curve with only with some minor spreading over the tube width. The estimated mixing rate of Device 3 is about 15%.

Data from an experimental setup of Device 4 (illustrated in FIG. 6C) is shown in FIG. 12. These two discs are masked 50% in baffle and perpendicular to the interface. Device 4 shows a large right shift of the position 3 curve illustrating an increase in mixing.

Device 4's right shift starts before the first disc and continues after the first and second disc. The three curves move to the right but still keep a bell shaped pattern. Therein, the water+dye component seems to be centralized in the middle of the flow, surrounded by glycerol. The estimated mixing rate of Device 4 is about 25%.

Data from an experimental setup of Device 5 (illustrated in FIG. 6D) is shown in FIG. 13. These two discs are masked 50% in baffle and perpendicular to each other. Device 5 shows a large right shift of the position 3 line illustrating an increase in mixing.

Device 5 also favors a shifting of the three curves to the right, but the curves are flattened, with an under curve surface spreading across the diameter of the tube, demonstrating a better mixing than Device 4.

Device 4 and Device 5 both include similar first disc fluid entry. However, the two Devices differ at the second disc, and therefore can behave differently when exiting the second. For Device 5, fluids in the chamber between the first and second discs need to move transversely to the right to find the exit from disc 2. This improves Device 5's quality of mixing.

Given the current fluid flows, a L2,1 configuration (Device 5) favors motion of the water+dye component to the right thereby leading to a position 3 curve spreading effect over ⅔ of the tube's diameter. The estimated mixing rate of Device 5 is about 40%.

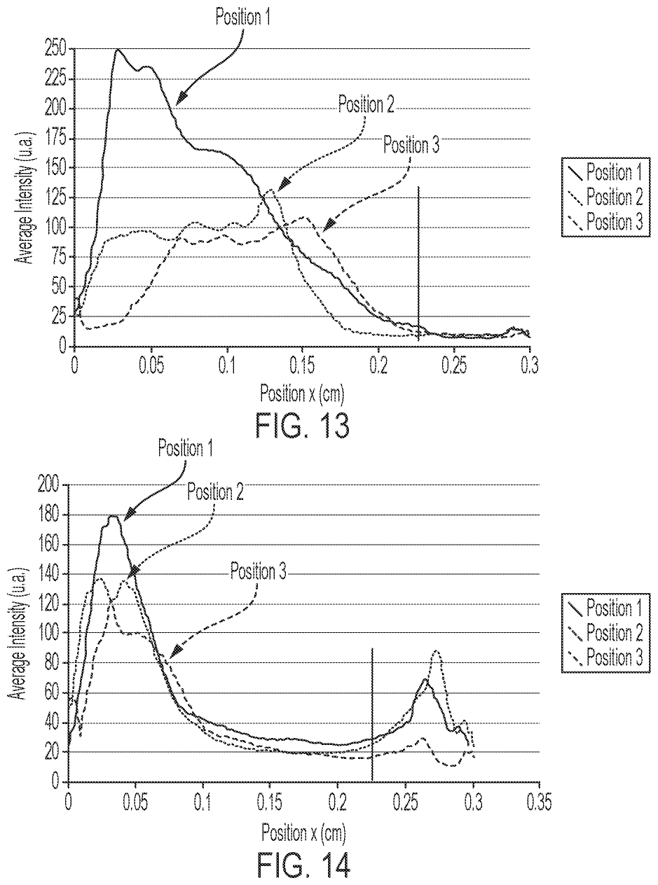

Data from an experimental setup similar to that illustrated in FIG. 6E is shown in FIG. 14, referred to as Device 6. This mixing configuration has two openings (void volume) which are alternated, the openings do not really distribute the two component flows. Opening L1,1 is favoring the direct passage of water+dye liquid (which has a higher flow rate). L2, 1 forces transverse motion to the right.

The curve from this Device 6 and the curve from the control Device 1 (FIG. 9) have a similar pattern. Thus, this mixing configuration can mix at least as well as the control device. Data shows that surface under the position 3 curve at 1 mm is wider than the control. The estimated mixing rate fro this configuration is about 10%-15%.

These experiments suggest that Device 5 and Device 4 offer the best mixing when compared to the other device configurations tested. Device 3 and Device 6 have similar configurations. However, Device 3 has a second disc in the L2,1 configuration that slightly improves mixing, but will contribute to build up of back pressure. Device 6 only including masks and not including porous portions does not exhibit this build up of back pressure that Device 3 does.

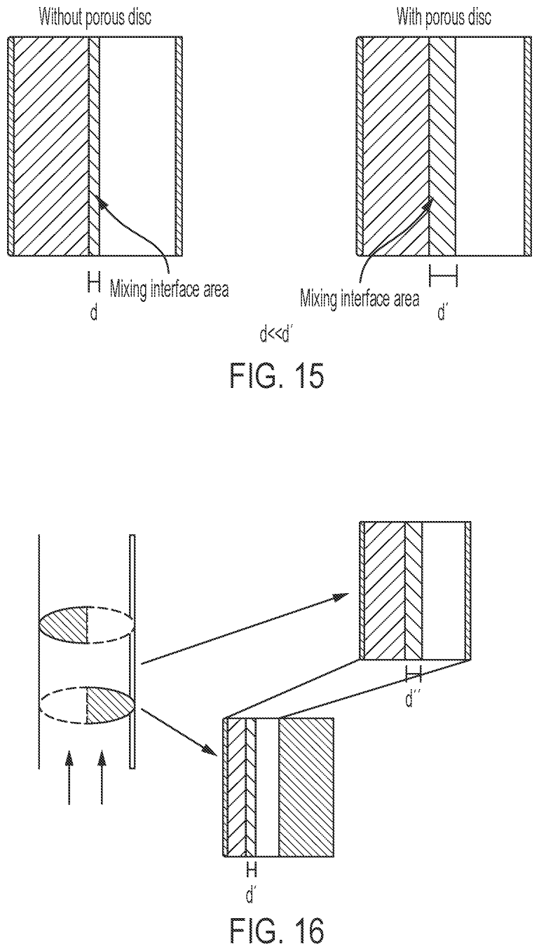

FIG. 15 illustrates a schematic mixing without and with a mixing disc. The data suggests that enhanced mixing of the different viscosity liquids has occurred when a porous disc is included in the device. This is evidenced by the enhanced mixing interface area between a device with and without a porous disc.

FIG. 16 illustrates a schematic mixing device with porous discs in a L1,3:L2,1 configuration. The data suggests that enhanced mixing of the different viscosity liquids has occurred after the liquids pass the first mixing disk. This is evidenced by the enhanced mixing interface area seen after the liquids pass the first mixing disc.

### Disclosed Embodiments

Embodiment 1. A mixing device comprising an inlet, a tube, a first mixing disc, a second mixing disc, and an outlet, wherein the first mixing disc, the second mixing disc, or a combination thereof comprise a truncation, a masking, or a combination thereof.

Embodiment 2. The mixing device of embodiment 1 configured to mix a composition including a first liquid having a first viscosity and a second liquid having a second viscosity wherein the second viscosity is greater than the first viscosity.

Embodiment 3. The mixing device of embodiment 1, wherein the first mixing disc comprises a truncation.

Embodiment 4. The mixing device of embodiment 1, wherein the second mixing disc comprises a truncation.

Embodiment 5. The mixing device of embodiment 1, wherein the first mixing disc comprises a masking.

Embodiment 6. The mixing device of embodiment 1, wherein the second mixing disc comprises a masking.

Embodiment 7. The mixing device of embodiment 1, further comprising a third mixing disc.

Embodiment 8. The mixing device of embodiment 8, wherein the third mixing disc comprises a truncation, a masking, or a combination thereof.

Embodiment 9. The mixing device of embodiment 1, further comprising a fourth mixing disc.

Embodiment 10. The mixing device of embodiment 9, wherein the fourth mixing disc comprises a truncation, a masking, or a combination thereof.

Embodiment 11. A method of mixing a composition including a first liquid having a first viscosity and a second liquid having a second viscosity wherein the second viscosity is greater than the first viscosity using the mixing device of embodiment 1.

In closing, it is to be understood that although aspects of the present specification are highlighted by referring to specific embodiments, one skilled in the art will readily appreciate that these disclosed embodiments are only illustrative of the principles of the subject matter disclosed herein. Therefore, it should be understood that the disclosed subject matter is in no way limited to a particular methodology, protocol, and/or reagent, etc., described herein. As such, various modifications or changes to or alternative configurations of the disclosed subject matter can be made in accordance with the teachings herein without departing from the spirit of the present specification. Lastly, the terminology used herein is for the purpose of describing particular embodiments only, and is not intended to limit the scope of the present disclosure, which is defined solely by the claims. Accordingly, embodiments of the present disclosure are not limited to those precisely as shown and described.

Certain embodiments are described herein, comprising the best mode known to the inventor for carrying out the methods and devices described herein. Of course, variations on these described embodiments will become apparent to those of ordinary skill in the art upon reading the foregoing description. Accordingly, this disclosure comprises all modifications and equivalents of the subject matter recited in the claims appended hereto as permitted by applicable law. Moreover, any combination of the above-described embodiments in all possible variations thereof is encompassed by the disclosure unless otherwise indicated herein or otherwise clearly contradicted by context.

Groupings of alternative embodiments, elements, or steps of the present disclosure are not to be construed as limitations. Each group member may be referred to and claimed individually or in any combination with other group members disclosed herein. It is anticipated that one or more members of a group may be comprised in, or deleted from, a group for reasons of convenience and/or patentability. When any such inclusion or deletion occurs, the specification is deemed to contain the group as modified thus fulfilling the written description of all Markush groups used in the appended claims.

Unless otherwise indicated, all numbers expressing a characteristic, item, quantity, parameter, property, term, and so forth used in the present specification and claims are to be understood as being modified in all instances by the term “about.” As used herein, the term “about” means that the characteristic, item, quantity, parameter, property, or term so qualified encompasses a range of plus or minus ten percent above and below the value of the stated characteristic, item, quantity, parameter, property, or term. Accordingly, unless indicated to the contrary, the numerical parameters set forth in the specification and attached claims are approximations that may vary. At the very least, and not as an attempt to limit the application of the doctrine of equivalents to the scope of the claims, each numerical indication should at least be construed in light of the number of reported significant digits and by applying ordinary rounding techniques. Notwithstanding that the numerical ranges and values setting forth the broad scope of the disclosure are approximations, the numerical ranges and values set forth in the specific examples are reported as precisely as possible. Any numerical range or value, however, inherently contains certain errors necessarily resulting from the standard deviation found in their respective testing measurements. Recitation of numerical ranges of values herein is merely intended to serve as a shorthand method of referring individually to each separate numerical value falling within the range. Unless otherwise indicated herein, each individual value of a numerical range is incorporated into the present specification as if it were individually recited herein.

The terms “a.” “an,” “the” and similar referents used in the context of describing the disclosure (especially in the context of the following claims) are to be construed to cover both the singular and the plural, unless otherwise indicated herein or clearly contradicted by context. All methods described herein can be performed in any suitable order unless otherwise indicated herein or otherwise clearly contradicted by context. The use of any and all examples, or exemplary language (e.g., “such as”) provided herein is intended merely to better illuminate the disclosure and does not pose a limitation on the scope otherwise claimed. No language in the present specification should be construed as indicating any non-claimed element essential to the practice of embodiments disclosed herein.

Specific embodiments disclosed herein may be further limited in the claims using consisting of or consisting essentially of language. When used in the claims, whether as filed or added per amendment, the transition term “consisting of” excludes any element, step, or ingredient not specified in the claims. The transition term “consisting essentially of” limits the scope of a claim to the specified materials or steps and those that do not materially affect the basic and novel characteristic(s). Embodiments of the present disclosure so claimed are inherently or expressly described and enabled herein.

1. A mixing device comprising:
an inlet,
a tube,
a first mixing disc,
a second mixing disc, and
an outlet,
wherein the first mixing disc, the second mixing disc, or a combination thereof comprise a truncation, a masking, or a combination thereof.

2. The mixing device of claim 1 configured to mix a composition including a first liquid having a first viscosity and a second liquid having a second viscosity wherein the second viscosity is greater than the first viscosity.

3. The mixing device of claim 1, wherein the first mixing disc comprises a truncation.

4. The mixing device of claim 1, wherein the second mixing disc comprises a truncation.

5. The mixing device of claim 1, wherein the first mixing disc comprises a masking.

6. The mixing device of claim 1, wherein the second mixing disc comprises a masking.

7. The mixing device of claim 1, further comprising a third mixing disc.

8. The mixing device of claim 8, wherein the third mixing disc comprises a truncation, a masking, or a combination thereof.

9. The mixing device of claim 1, further comprising a fourth mixing disc.

10. The mixing device of claim 9, wherein the fourth mixing disc comprises a truncation, a masking, or a combination thereof.

11. A method of mixing a composition including a first liquid having a first viscosity and a second liquid having a second viscosity wherein the second viscosity is greater than the first viscosity using the mixing device of claim 1.
